(19) United States
(12) Patent Application Publication
(10) Pub. No.: US 2007/0278251 A1
(43) Pub. Date: Dec. 6, 2007

(54) Dispensing Apparatus

(76) Inventors: Angelo Guerrera, Padstow New South Wales (AU); Robert Gale, Padstow New South Wales (AU); Mahmound Chemait, Moorebank New South Wales (AU)

Correspondence Address: BLAKELY SOKOLOFF TAYLOR & ZAFMAN, 12400 Wilshire Blvd, Seventh Floor, Los Angeles, CA, 90025-1026, US

(21) Appl. No.: 10/451,671

(22) PCT Filed: Dec. 21, 2001
(86) PCT No.: PCT/AU01/01653

§ 371 Date: Apr. 19, 2004

(30) Foreign Application Priority Data
Dec. 22, 2000 (AU) PR 2487

(51) Int. Cl. B67D 5/00; B65D 35/56; G01F 11/00; B65D 88/54

(52) U.S. Cl. 222/327; 222/386; 222/105; 222/82

(57) ABSTRACT

A dispensing apparatus (1) including a combination of a tube (2), cap (4) and plunger (3). The tube is arranged for carrying a collapsible sausage (6) and includes longitudinally extending ribs (8) projecting inwardly of the tube and defining longitudinal grooves (7) therebetween, the grooves having an annular dimension (A) greater than the distance (B) between adjacent ribs. The cap includes: a coupling portion (20) for mounting the cap to the tube; an outlet (21) through which contents of the collapsible sausage carried within the tube arc dispensed; and a chamber (22) into which the sausage is adapted to be collapsed under action of the plunger within the tube. The plunger itself has a main body (11) with radial fins (10) projecting therefrom for receipt in the grooves of the tube, between adjacent ribs, the fins being dimensioned to engage lateral edges of the ribs, in a point contact manner.

### FIELD OF THE INVENTION

The present invention relates to a dispensing apparatus particularly an apparatus for dispensing contents from a collapsible sausage.

### BACKGROUND OF THE INVENTION

It is known to dispense contents of a collapsible sausage from a caulking gun arrangement or the like which carries a tube, with a plunger. The plunger is intended to be reversible within the tube for subsequent dispensing of contents from another sausage, in a reverse direction.

The known arrangement is, however, considered to be inadequate insofar as the plunger tends to got jammed and replacement of the sausage can be somewhat messy.

### OBJECT OF THE INVENTION

The present invention seeks to address the above inadequacies.

### SUMMARY OF THE INVENTION

In accordance with the present invention, there is provided a tube for carrying a collapsible sausage and dispensing contents therefrom, the tube having longitudinally extending ribs projecting inwardly of the tube and defining longitudinal grooves therebetween, the grooves having an annular dimension greater than the distance between adjacent ribs.

Preferably, the ribs and grooves extend substantially the entire length of the tube.

Preferably, ends of the tube arc provided with inwardly directed stop surfaces for capturing a plunger therebetween.

Preferably, ends of the tube are provided with an inwardly directed lip for engaging with and securing a cap relative thereto.

In another aspect, there is provided a cap for use with the above tube, the cap having:
a coupling portion for mounting the cap to the tube;
an outlet through which contents of the collapsible sausage carried within the tube are dispensed; and
a chamber into which the sausage is adapted to be collapsed under action of a plunger within the tube.

Preferably, the coupling portion includes a spline formed on an outer surface of the cap for receipt in an associated groove of the tube.

Preferably, the cap includes a well, provided within the chamber for receipt of an end clip of the sausage.

Preferably, the cap includes piercing structure projecting from a base of the cap for puncturing the sausage.

Preferably, the piercing structure is provided in the well, adjacent the outlet.

Preferably, the piercing structure includes two teeth positioned toward either side of the outlet.

More preferably, one of the teeth projects a lesser distance from the base of the cap and includes a vane directed away from an other of the teeth, so as to tension the sausage away from a puncture zone and facilitate propagation of a tear in the sausage.

Preferably, the cap includes a shroud arranged adjacent the well, on a side of the outlet opposite the piercing structure, the shroud serving to impart a turning moment at an end of the sausage so as to deflect the end clip of the sausage into the well at a location offset from the outlet.

Preferably, the shroud is formed by a series of arc-shaped ribs.

Preferably, the cap is provided with a rebate on an exterior surface thereof for engagement with a complimentary lip of the tube, for securing the cap relative to the tube.

In another aspect, there is provided a plunger for use in the above described tube, the plunger having a main body with radial fins projecting therefrom for receipt in the grooves of the tube, between adjacent ribs, the fins being dimensioned to engage lateral edges of the ribs, in a point contact manner.

Preferably, the body of the plunger includes a central bulb for driving the sausage into a cap coupled so the tube.

Preferably, the plunger includes a reduced dimension region between the bulb and the fins.

Preferably, the bulb includes a bore for receipt of an end clip of the sausage.

Preferably, the plunger is symmetric and reversible.

In another aspect, there is provided a dispensing apparatus including a combination of the tube, cap and plunger, as described above.

### BRIEF DESCRIPTION OF THE DRAWINGS

The invention is described, by way of non-limiting example only, with reference to the drawings, in which:

FIG. 1 is an exploded sectional view of a dispensing apparatus;

FIG. 2 is a view of the apparatus of FIG. 1, showing a sausage in a collapsed state;

FIG. 3 is an end view of the plunger of the apparatus of FIG. 1;

FIG. 4 is a partial cross-sectional view of the plunger received in the tube;

FIG. 5 is a cross-sectional view of an alternative form of plunger;

FIG. 6 is a cross-sectional view of a cap of the apparatus of FIG. 1;

FIG. 7 is an end view of the cap of FIG. 6;

FIG. 8 is a cross-sectional view of an alternative cap for use with the apparatus of FIG. 1; and

FIG. 9 is an end view of the cap of FIG. 8.

### DETAILED DESCRIPTION

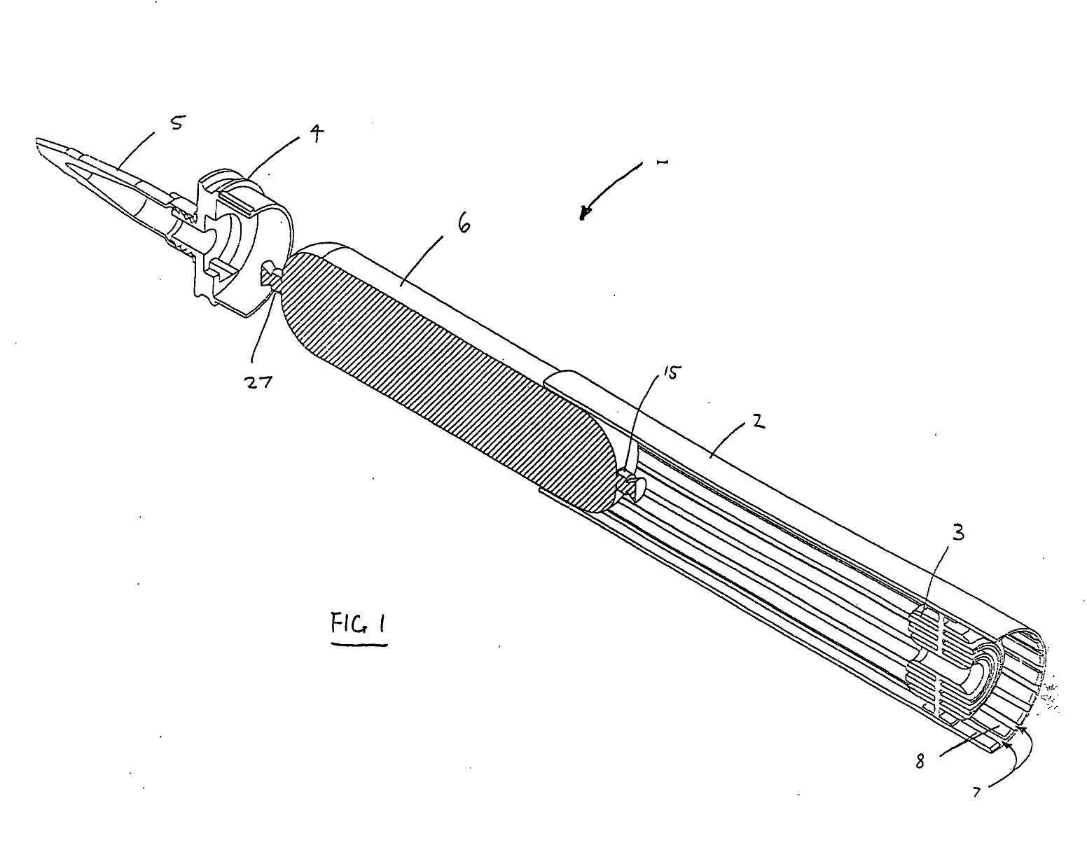

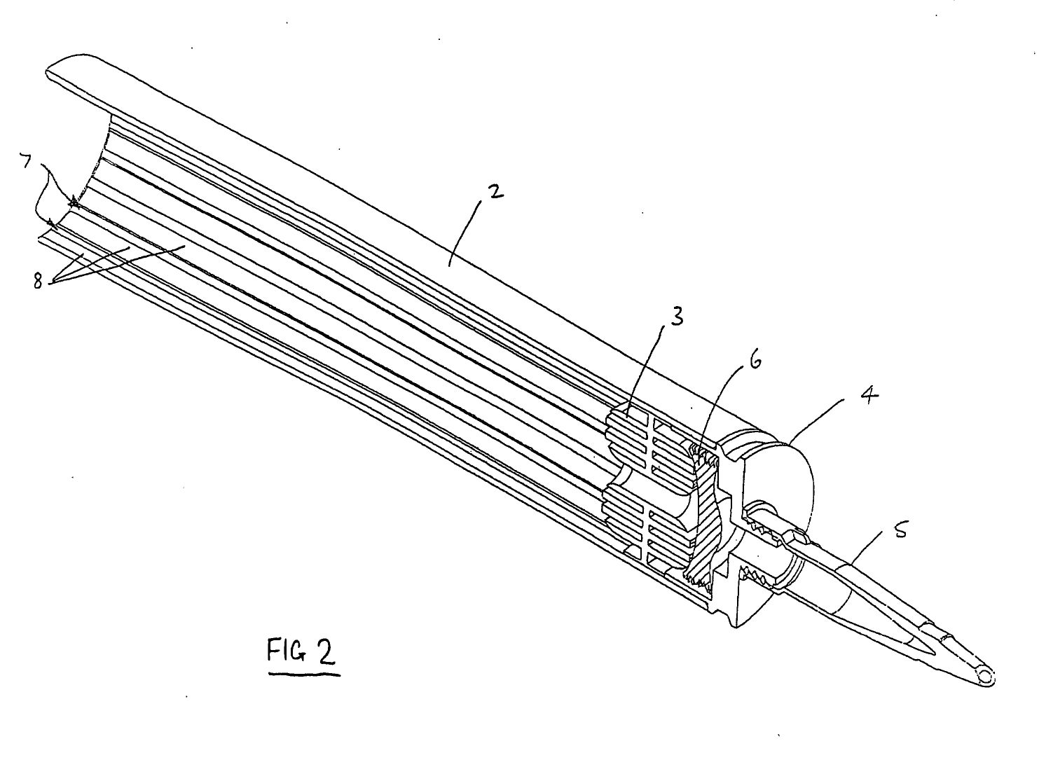

Referring firstly to FIG. 1, an apparatus 1 is shown as comprising a tube 2, a plunger 3 and an end cap 4 with a nozzle 5 fitted thereto. The tube is arranged to carry a collapsible sausage 6 and the plunger is in use driven along the tube 2 by a piston of a dispenser (not shown) such as a caulking gun, or the like, so as to collapse the sausage 6 and dispense the contents thereof from the nozzle 5. The sausage is shown in a collapsed condition in FIG. 2.

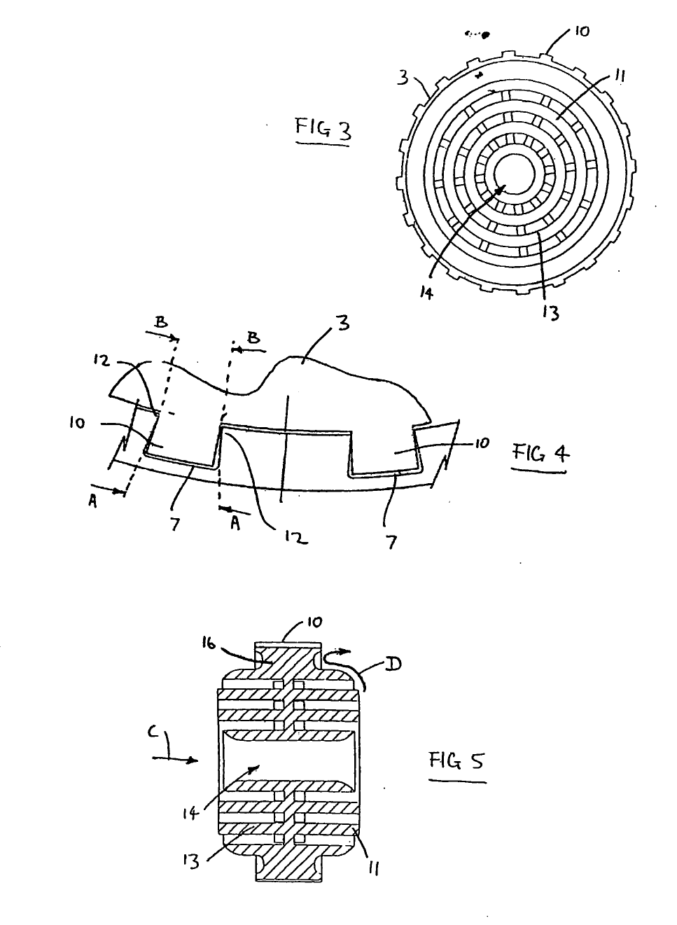

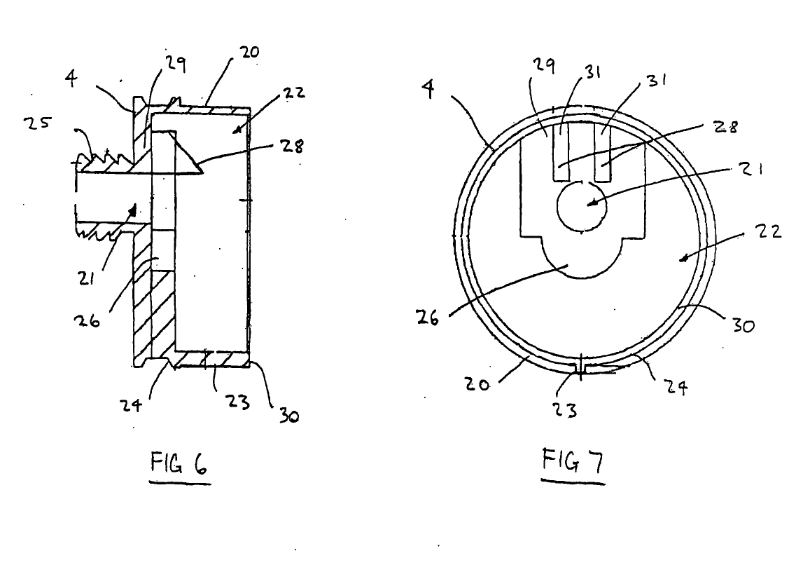

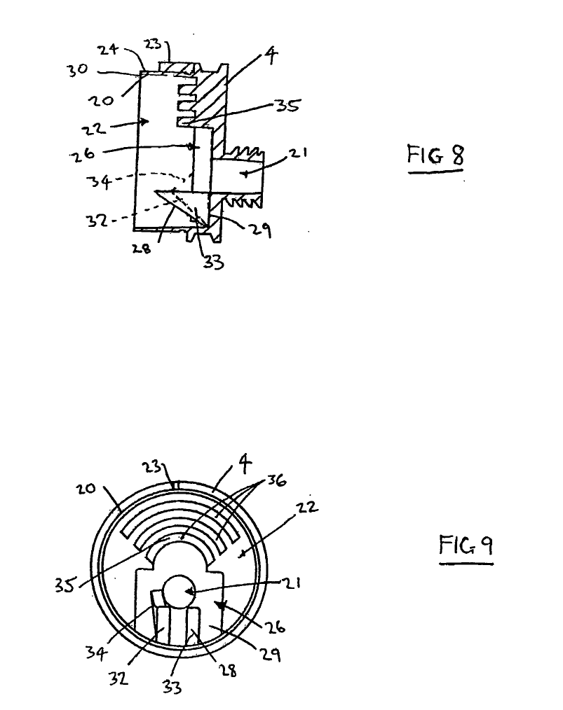

In order to ensure smooth and reliable travel of the plunger 3, the tube 2 is provided with a plurality of grooves 7, between adjacent longitudinal extending ribs 8. The plunger 3 has corresponding fins 10 projecting radially from a main body 11, as shown at FIG. 3, for receipt in the grooves 7. The interconnection between the plunger 3 and grooves 7 is shown in more detail in FIG. 4, wherein it can be seen that an annular dimension “A” of the grooves is greater than the distance “B” between lateral edges 12. The fins 10 are dimensioned to engage with the tube 2 only along the lateral edges 12, thereby establishing a point contact form of connection which has the effect of minimising friction between the plunger 3 and the tube 2.

To maximise efficiency of dispensing contents from the sausage 6, the main body 11 of the plunger 3 is provided with a central bulb 13, for driving the sausage 6 into the cap 4. The bulb 13 is preferably formed with a bore 14 for receipt of an end clip 15 of the sausage 6. In an alternative form, the plunger 3 may have a reduced dimension region 16, as shown in FIG. 5, which allows the collapsed sausage material, which is forced down over the bulb 13 to be scooped back toward the direction of travel “C” of the plunger, as indicated by arrow “D” so that the sausage does not jam between the plunger 3 and the tube 2.

As can be seen from the drawings, the plunger 3 is symmetrically formed so as to allow for reversibility. For that purpose, the ends of the tube 2 may be provided with inwardly directed stop surfaces (not shown) for capturing the plunger 3 therebetween or, alternatively, the cap may itself be utilised to provide an end of travel stop for the plunger.

The construction of the end cap 4 itself is shown in more detail in FIGS. 6 and 7. The cap 4 includes a coupling portion 20, for mounting the cap 4 to the tube 2, an outlet 21 through which contents of the sausage 6 are dispensed and a chamber 22, into which the sausage is adapted to be collapsed, under action of the plunger 3. The coupling portion 20 may be provided with a spline 23 on an outer surface 24 of the cap 4 for receipt in an associated groove 7 of the tube 2. The spline 23 serves to prevent the cap 4 rotating relative to the tube 2 when the nozzle 5 is removed or attached to screw thread 25. The cap also includes a well 26 to receive an end clip 27 of the sausage 6 and a piercing structure 28 which projects from a base 29 of the cap for puncturing the sausage 6. The structure 28 is formed of two identical teeth 31, located adjacent and toward opposite sides of the outlet 21, which is in turn located off-centre of the cap to ensure the clip 27, which is received in the well 26, does not block the flow of the sausage contents therethrough. The off-centre arrangement of the outlet also provides an advantage in that a user can more readily dispense material into corners or otherwise awkward to access locations.

An alternative cap conduction is shown in FIGS. 8 and 9, where like reference numerals designate like parts to those shown in FIGS. 6 and 7. Instead of having piercing structure formed of two identical teeth 31, however, one of the teeth 32 projects from the base 29 by a lesser extent than the other of the teeth 33 and is provided with a vane 34, so as to tension the sausage away from a puncture zone and facilitate propagation of a tear in the sausage.

The cap 4 of FIGS. 8 and 9 also includes a shroud 35, on a side of the outlet 21 opposite the piercing structure. The shroud serves to impart a turning moment at an end of the sausage, as it is driven into the cap 4, so as to deflect the and clip 27 into the well 26, at a location offset from the outlet 21. The shroud is formed of a series of annularly arranged arc-shaped ribs 36. The ribs 36 also serve to further tension the sausage in the vicinity of the piercing structure 28 and assist in reducing residue material within the sausage after a dispensing operation.

FIG. 8 also shows the cap 4 as including a rebate 37 on the exterior surface 24, which is arranged for engagement with a complimentary lip which may be provided in the tube for securing the cap 4 to the tube 2.

As mentioned above, the cap 4 may serve as an end of travel stop for the plunger 3 either by the plunger engaging directly with an end wall 30 of the portion 20 or by the plunger 3 compacting sausage 6 against the structure 28, as well as the shroud 35. In either case, once the contents of the sausage have been fully dispensed, the sausage may be conveniently removed from the tube by uncoupling the cap 4 from the tube, with the collapsed sausage still held within the chamber 22, for the sausage to be discarded. Another full sausage can then be inserted in the tube and the rap 4 reattached to the tube at the opposite end thereof, for another dispensing operation.

The invention has been described by way of non-limiting example only and many modifications and variations may be made thereto without departing from the spirit and scope of the invention as described.

1. A tube for carrying a collapsible sausage and dispensing contents therefrom, the tube having longitudinally extending ribs projecting inwardly of the tube and defining longitudinal grooves therebetween, the grooves having an annular dimension greater than the distance between adjacent ribs.

2. A tube as claimed in claim 1, wherein the ribs and grooves extend substantially the entire length of the tube.

3. A tube as claimed in claim 1 or 2, wherein ends of the tube are provided with inwardly directed stop surfaces for capturing a plunger therebetween.

4. The ends of the tube are provided with an inwardly directed lip for engaging with and securing a cap relative thereto.

5. A cap for use with the above tube, the cap having:
a coupling portion for mounting the cap to the tube;
an outlet through which contents of the collapsible sausage carried within the tube are dispensed; and
a chamber into which the sausage is adapted to be collapsed under action of a plunger within the tube.

6. A cap as claimed in claim 5, wherein the coupling portion includes a spline formed on an outer surface of the cap for receipt in an associated groove of the tube.

7. A cap as claimed in claim 5 or 6, wherein the cap includes a well, provided within the chamber for receipt of an end clip of the sausage.

8. A cap as claimed in any one of claims 5 to 7, wherein the cap includes piercing structure projecting from a base of the cap for puncturing the sausage.

9. A cap as claimed in claim 8, wherein the piercing structure is provided in the well, adjacent the outlet.

10. A cap as claimed in claims 8 or 9, wherein the piercing structure includes two teeth positioned toward either side of the outlet.

11. A cap as claimed in claim 10, wherein one of tho teeth projects a lesser distance from the base of the cap and includes a vane directed away from an other of the teeth, so as to tension the sausage away from a puncture zone and facilitate propagation of a tear in the sausage.

12. A cap as claimed in any one of claims 8 to 11, wherein the cap includes a shroud arranged adjacent the well, an a side of the outlet opposite the piercing structure, the shroud serving to impart a turning moment at an end of the sausage so as to deflect the end clip of the sausage into the well at a location offset from the outlet.

13. A cap as claimed in claim 12, wherein the shroud is formed by a series of arc-shaped ribs.

14. A cap as claimed in any one of claims 6 to 13, wherein the cap is provided with a rebate on an exterior surface thereof for engagement with a complimentary lip of the tube, for securing the cap relative to the tube.

15. A plunger for use in the above described tube, the plunger having a main body with radial fins projecting therefrom for receipt in the grooves of the tube, between adjacent ribs, the fins being dimensioned to engage lateral edges of the ribs, in a point contact manner.

16. A plunger as claimed in claim 15, wherein the body of the plunger includes a central bulb for driving the sausage into a cap coupled to the tube.

17. A plunger as claimed in claim 16, wherein the plunger includes a reduced dimension region between the bulb and the fins.

18. A plunger as claimed in claim 17, wherein the bulb includes a bore for receipt of an end clip of the sausage.

19. A plunger as claimed in any one of claims 16 to 18, wherein the plunger is symmetric and reversible.

20. A dispensing apparatus including:
a tube, as claimed in any one of claims 1 to 4;
a cap, as claimed in any one of claims 6 to 14, and
a plunger, as claimed in any one of claims 15 to 19.
